(19) United States
(12) Patent Application Publication
(10) Pub. No.: US 2026/0320598 A1
(43) Pub. Date: Oct. 15, 2026

(54) TRANSACTION AUTHORIZATION BASED ON USER STATUS INDICATORS

(71) Applicant: Wells Fargo Bank, N.A., San Francisco, CA (US)

(72) Inventors: Marc Le boeuf, Menlo Park, CA (US); Dennis Emmanuel Montenegro, Concord, CA (US); Ramesh Yarlagadda, Charlotte, NC (US); Jason Huang, San Francisco, CA (US); Sadie Salim, Albany, CA (US)

(21) Appl. No.: 19/179,783

(22) Filed: Apr. 15, 2025

(51) Int. Cl. G06Q 20/40; G06Q 20/38

(52) U.S. Cl. CPC G06Q 20/40; G06Q 20/382

(57) ABSTRACT

Techniques are described for the computer-based authorization of transactions based on the physical availability of a user. The disclosed techniques include a computing system configured to obtain one or more status indicators of at least one of a user or a user computing device of the user, determine, based on the one or more status indicators, an inference associated with a physical condition of the user, determine, based on the inference, whether to authorize processing of a transaction initiated on an account of the user, and, based on the determination, send a message to another computing system to cause the another computing system to one of block or allow the transaction on the account of the user.

### TECHNICAL FIELD

This disclosure relates to computing systems, and more specifically, computing systems that monitor and/or authorize transactions.

### BACKGROUND

Organizations may maintain one or more accounts for customers, e.g., financial services accounts, reward accounts, social media accounts, and the like. An organization may monitor transactions associated with an account to determine whether erroneous, fraudulent, illegal, or otherwise improper transactions are taking place on accounts they maintain. For example, a fraud monitoring system may determine that one or more completed transactions are anomalous based on disparities between the transactions and a customer’s typical behavior or known location. The organization may determine that the completed transactions are fraudulent (e.g., not made by the customer associated with the account).

If such fraudulent transactions are detected or reported by the customer associated with the account, the organization may take appropriate actions to reverse or remediate the completed transactions and/or prevent additional fraudulent transactions, which may include refunding or otherwise undoing the transactions and limiting use of or closing affected account(s).

### SUMMARY

In general, this disclosure describes techniques for proactively blocking transactions on a user account based on an inference that the associated user is physically unavailable to make the transactions. The disclosed techniques enable a computing system to infer a physical condition of a user based on obtaining one or more status indicators of at least one of the user or a user computing device of the user, such as a smart watch or other wearable, a smart phone, and/or a tablet. The techniques enable the computing system to determine, using an inference engine comprising one or more machine learning (ML) models and based on the one or more status indicators, an inference indicating whether the user is physically available to initiate the transaction or is physically unavailable to initiate the transaction. For example, when a status indicator obtained from a user’s smart watch indicates that the user is asleep, the inference engine may determine that the user is physically unavailable to initiate transactions on the user’s accounts.

For transactions initiated on the user’s accounts after the determination that the user is physically unavailable, the computing system may determine to block or deny the new transactions. In order to block the new transactions initiated on the user’s accounts, the computing system may quarantine the new transactions or may send a message to another computing system, such as a transaction management system, with instructions to cause the other computing system to deny the new transactions. In some examples, the computing system may send additional messages to additional computing systems to cause those computing systems to perform additional actions, such as generating a notification to the user or opening a new ticket or case in a fraud prevention system.

Conventionally, organizations may use various fraud detection techniques to identify potentially fraudulent activity associated with completed transactions on a given account. For example, an organization may use information, such as the location of a user computing device associated with an account, the location of a transaction, or the monetary amount associated with a transaction, to determine whether the transaction is valid (e.g., made by an authorized user associated with the account) or fraudulent (e.g., made by an unauthorized user).

Conventional fraud detection techniques may primarily assist organizations in identifying or detecting fraudulent activity that has already occurred. For example, when an organization flags a transaction as potentially fraudulent, the flag may trigger one or more additional actions, such as placing a temporary hold on an account or initiating a chargeback to an account. However, while the conventional techniques may be sufficient to mitigate fraudulent activity that has already occurred, the conventional techniques may be unable to efficiently and/or effectively preemptively prevent or otherwise stop fraudulent actions from occurring.

The techniques of this disclosure provide one or more technical improvements that may be used to realize practical advantages. For example, the techniques enable a computing system to preemptively block transactions initiated on a user’s accounts during a time period in which the user is determined to be physically unavailable to initiate the transactions. In this way, the transactions may be blocked based on the physical unavailability of the user until the user overrides the block (i.e., once the user is again physically available), rather than the computing system performing a unique determination for each transaction initiated on the user’s accounts during the time period. For example, if three transactions are attempted while a user is unavailable, the techniques of this disclosure may enable the computing system to automatically prevent all three transactions from occurring (e.g., being processed and/or completed). Conversely, in a similar scenario, conventional systems may require a computing system to determine the validity of each of the three transactions individually, as each transaction is processed, and further determine fraudulent activity if one of the transactions is later flagged as anomalous after being completed.

The techniques may also enable a computing system to automatically monitor and place restrictions on multiple accounts. For example, with conventional methods, a user traveling may need to manually disable (e.g., temporarily deactivate, etc.) or place restrictions (e.g., no new, unscheduled transactions) on each of multiple different accounts. The techniques of this disclosure may enable a computing system to automatically disable or otherwise restrict transactions on a group of accounts including multiple different accounts and/or different types of accounts in response to determining the user is unavailable. As such, the disclosed techniques may reduce resource usage (e.g., compute, storage, and/or power usage), making the computing system operate more efficiently.

As another example, the computing system may improve one or more ML models of the inference engine over time. For example, the inference engine may be configured to classify the physical condition of a user as available or unavailable. In some examples, the computing system may obtain feedback from one or more users regarding one or more determinations of the inference engine. For example, the computing system may obtain feedback from a user indicating that the user’s transactions were erroneously blocked during a time when the user was physically available. The computing system may use the user feedback to fine-tune parameters of the one or more ML models and/or as a portion of training data used to retrain the one or more ML models. In another example, the computing system may obtain additional information from one or more third-party sources, such as a microservice associated with a sleep management application. The computing system may use the additional information to fine-tune and/or retrain the one or more ML models. In this way, the techniques enable the computing system to improve the accuracy and/or speed of the inference engine. For example, by re-training the ML models in response to receiving user feedback that the system erroneously determined that the user was unavailable, the models may be able to more accurately interpret similar input status indicators in future determinations (e.g., increasing the ability of the inference engine to properly identify when a user is available or unavailable).

In one example, this disclosure is directed towards a system comprising memory and one or more processors in communication with the memory and configured to obtain one or more status indicators of at least one of a user or a user computing device of the user; determine, based on the one or more status indicators, an inference associated with a physical condition of the user; determine, based on the inference, whether to authorize processing of a transaction initiated on an account of the user; and based on the determination, send a message to another computing system to cause the another computing system to one of block or allow the transaction on the account of the user.

In another example, this disclosure is directed towards a method comprising obtaining, by a computing system, one or more status indicators of at least one of a user or a user computing device of the user; determining, by the computing system and based on the one or more status indicators, an inference associated with a physical condition of the user; determining, by the computing system and based on the inference, whether to authorize processing of a transaction initiated on an account of the user; and based on the determination, sending a message from the computing system to another computing system to cause the another computing system to one of block or allow the transaction on the account of the user.

In an additional example, this disclosure is directed towards non-transitory computer-readable storage media comprising instructions that, when executed, cause one or more processors to obtain one or more status indicators of at least one of a user or a user computing device of the user; determine, based on the one or more status indicators, an inference associated with a physical condition of the user; determine, based on the inference, whether to authorize processing of a transaction initiated on an account of the user; and based on the determination, send a message to another computing system to cause the another computing system to one of block or allow the transaction on the account of the user.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE FIGURES

FIG. 1 is a block diagram illustrating an example network system including an availability determination system, in accordance with one or more aspects of this disclosure.

FIG. 2A is a block diagram illustrating an example computing system, in accordance with one or more aspects of the present disclosure.

FIG. 2B is a conceptual diagram illustrating an example operation of training an inference engine used by the computing system of FIG. 2A, in accordance with one or more aspects of the present disclosure.

FIG. 3 is a flow diagram illustrating an example operation of determining the physical availability of a user and blocking or approving a transaction of the user, in accordance with one or more techniques of this disclosure.

### DETAILED DESCRIPTION

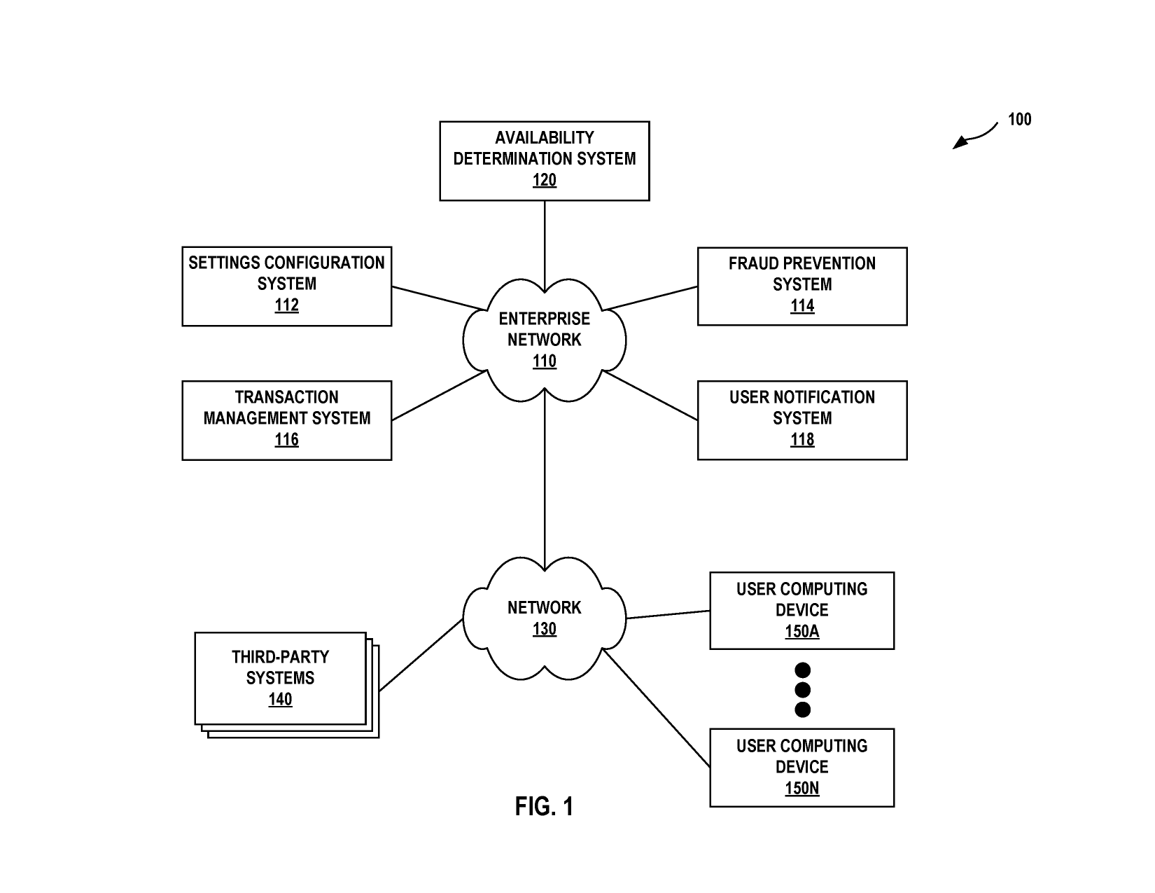

FIG. 1 is a block diagram illustrating an example enterprise network system 100 including an availability determination system 120, in accordance with one or more aspects of this disclosure. A transaction is generally defined as an exchange or transfer between two or more parties. In some examples, a transaction may include one or more units of value, generally defined as a transferable or exchange form of tender than may be accepted as a form of payment, such as currencies, cryptocurrencies, securities (e.g., stocks, bonds, etc.), reward points, loyalty credits, property rights, or non-fungible tokens (NFTs). In other examples, a transaction may include the transfer or exchange of one or more units of data. For example, a transaction may include a post on a social media platform (e.g., the transfer of data between the computing device of a user and a computing device managed by the social media platform).

Network system 100 includes an enterprise network 110 and a network 130. Enterprise network 110 may be a private, large-scale enterprise network used or administered by an organization, such as a financial institution, bank, medical facility, or other type of organization, which will commonly rely on significant computing resources. For some large organizations, computing and storage resources may be provided through multiple data centers (not shown) deployed within enterprise network 110. Moreover, various applications, services, or other tools used by employees or other users of the organization may be accessible either within enterprise network 110 or from various cloud-based service providers via network 130.

Devices connected to enterprise network 110 may be part of a secure network not normally accessible to the public. Although enterprise network 110 is illustrated as a single network and may be principally located within one location, enterprise network 110 may also comprise multiple networks and be geographically distributed across multiple locations. A number of devices and/or systems are shown connected to enterprise network 110 in FIG. 1. Such devices and systems include availability determination system 120, settings configuration system 112, fraud prevention system 114, transaction management system 116, and user notification system 118.

Network 130 may be primarily described as a public network, such as the internet. However, techniques in accordance with one or more aspects of the present disclosure may apply to similar systems in which network 130 is implemented as a private network. Network 130 may be used by third-party systems 140 and user computing devices 150A-150N (collectively, “user computing devices 150”) to interact with (e.g., communicate with, access, be accessed by, etc.) one or more components and/or systems connected to enterprise network 110, such as settings configuration system 112, user notification system 118, or availability determination system 120. In some examples, one or more of third-party systems 140 may also be hosted by cloud-based service providers and accessible via network 130.

Enterprise network 110 and network 130 illustrated in FIG. 1 may include or represent any public or private communications network or other network. One or more client devices, server devices, or other devices may transmit and receive data, commands, control signals, and/or other information across such networks using any suitable communication techniques. In some examples, Enterprise network 110 and network 130 may be a separate network as illustrated in FIG. 1, or one or more of such networks may be a subnetwork of another network. In other examples, two or more of such networks may be combined into a single network; further, one or more of such networks may be, or may be part of, the internet. Accordingly, one or more of the devices or systems illustrated in FIG. 1 may be in a remote location relative to one or more other illustrated devices or systems. Enterprise network 110 and network 130 illustrated in FIG. 1 may include one or more network hubs, network switches, network routers, network links, satellite dishes, or any other network equipment. Such devices or components may be operatively inter-coupled, thereby providing for the exchange of information between computers, devices, or other components (e.g., between one or more user devices or systems and one or more server devices or systems).

User computing devices 150 may be devices that are used by one or more users of network system 100. User computing devices 150 may represent standard devices that are utilized by one or more users (e.g., customers, clients, account managers, etc.) of the organization responsible for managing enterprise network 110. For example, in one example, user computing device 150A may be a mobile phone (e.g., smartphone) utilized by one customer of the organization. In another example, user computing device 150B may be a wearable computing device (e.g., smartwatch, smart glasses, etc.) utilized by another client of the organization. Each of user computing devices 150 may be used to access and interact with other systems, devices, and components across enterprise network 110 via network 130.

The organization responsible for managing enterprise network 110 may be responsible for managing (e.g., receiving, monitoring, approving, etc.) one or more transactions that arise from one or more users. As one example, the organization may be a financial institution, such as a bank, responsible for receiving transactions requests from payment processors, authorizing transactions (e.g., determining if the user has sufficient funds accessible, if the transaction is valid, etc.), approving or blocking transactions, and transferring funds from the user’s account to the party that sent the transaction request. However, in other examples, the organization may be another business, such as a food delivery service or an online marketplace, that may receive transactions (e.g., food orders, physical object purchases, digital content purchases, etc.).

Conventionally, organizations may use various fraud detection techniques to identify potentially fraudulent activity (e.g., transactions not initialized by an account owner and/or manager) associated with a given account. For example, an organization managing enterprise network 110 may receive and authorize multiple transactions on a user account. The organization may determine whether any of the transactions are anomalous (e.g., in a location different than the current or frequented locations of users associated with the account, of a monetary value dissimilar to previous transactions associated with the account, etc.) using information such as the transaction history or current location of a user. If a transaction is anomalous, or the organization receives information, such as a report or complaint from a user, the organization may flag the transaction as potentially fraudulent, initiating investigation processes, rolling back the transaction (e.g., initiating a chargeback) on behalf of the account, or placing a temporary hold on the account.

While conventional fraud detection techniques may assist organizations in identifying or detecting fraudulent activity, conventional methods are substantially limited to identifying anomalies and fraudulent behavior in transactions that have already occurred. That is, while conventional techniques may be sufficient to mitigate fraudulent activity that has already occurred, the conventional techniques may be unable to efficiently and/or effectively preemptively prevent or otherwise stop fraudulent actions from occurring.

In some examples, fraudulent or unauthorized activity may occur that is unable to be detected through traditional detection methods. For example, an account may belong to one user of a household, wherein the household consists of one adult (e.g., the account owner) and two children. While the user is asleep, another member of the household, such as one of the two children, may use the account of the user to complete a transaction, such as a purchase at a local convenience store. Traditional methods may fail to determine that this transaction is fraudulent, due to the low monetary value of the transaction and local location, unless later identified by the user as fraudulent (e.g., through a report or complaint to the organization). Similarly, other examples of fraudulent behavior may not be caught by conventional techniques if factors such as location or monetary thresholds are not dissimilar enough from the standard behavior of a user for the conventional techniques to identify any anomalies.

In general, this disclosure describes techniques for proactively blocking transactions on a user account based on an inference that the associated user is physically unavailable to make the transactions. The disclosed techniques enable availability determination system 120 to infer a physical condition of a user based on obtaining one or more status indicators of the user and/or the user computing device of the user, e.g., one of user computing devices 150. Availability determination system 120 may obtain one or more status indicators pertaining to a user (e.g., from user computing devices 150, third-party systems 140, etc.), and may generate an inference indicating whether the user is physically available to initiate the transaction or is physically unavailable to initiate the transaction (e.g., indicating potentially fraudulent behavior and/or an unauthorized transaction). Availability determination system 120 may use the inference to determine whether to authorize processing of a transaction initiated on an account of the user and, based on the determination, direct another system, such as transaction management system 116, to block or allow the transaction on the account.

Availability determination system 120 may be configured to obtain one or more status indicators associated with a user. In some examples, a status indicator may include information indicative of one or more activity states of the user. For example, a status indicator may include information that the user is asleep, exercising, or driving. In other examples, a status indicator may include information indicative of one or more settings on a user computing device associated with the user (e.g., user computing device 150A). In some examples, availability determination system 120 may obtain a status indicator from interacting with user computing device 150A of the user. As one example, availability determination system 120 may obtain a status indicator from user computing device 150A indicating the connectivity state of the user computing device (e.g., airplane mode, bedtime mode, not connected to a cellular network, etc.). For example, availability determination system 120 may obtain a status indicator indicating that the user computing device is not connected to data or any cellular network (e.g., connected to the Internet through a non-cellular connection, such as WIFI).

In other examples, availability determination system 120 may obtain a status indicator from interacting with one or more of third-party systems 140. Each of third-party systems 140 may be any system managed by a third-party organization (e.g., an organization separate from the organization responsible for managing enterprise network 110). Each of third-party systems 140 may be cloud-based services that a user may access or interact with through one or more applications or services on any of user computing devices 150 (e.g., browser applications, applications created and/or managed by a third-party organization, etc.). As one example, one of third-party systems 140 may be managed by an organization that manages a fitness application. The third-party system may store fitness-related information (e.g., workout history, steps, etc.) obtained from the application as hosted on user computing device 150A. Availability determination system 120 may interact with the third-party system to obtain a status indicator related to the activity state of the user, detailing the user is currently exercising.

In some examples, the status indicators obtained by availability determination system 120 may be a completed value or state. As one example, a status indicator obtained from one of third-party systems 140, such as one managed by a fitness application, may indicate the user is currently exercising. In other examples, the status indicators obtained by availability determination system 120 may be values used to determine one or more states. As one example, availability determination system 120 may obtain multiple status indicators from one of third-party systems 140, such as one managed by a fitness application, such as a heart rate or step count, that may be used to determine a state for the user.

Availability determination system 120 may be configured to use the one or more status indicators to determine an inference associated with a physical condition of the user. Availability determination system 120 may be configured to interact with and/or store one or more ML models trained on historical status indicators and configured to determine the physical condition of the user. The one or more ML models may determine that, based on the status indicators, the user is either physically available (e.g., able to make or initiate a transaction) or physically unavailable (e.g., unable to make or initiate a transaction). For example, the ML models may determine an inference pertaining to the availability of a user based on two status indicators obtained pertaining to a user – the activity state of the user and the current state of a computing device associated with the user (e.g., user computing device 150A). The status indicators may show that the current activity state of the user is asleep, and that the connectivity state of user computing device 150A is a sleep mode (e.g., bedtime mode). The ML models may determine, based on the status indicators, that the user is unavailable to make transactions (e.g., since the user is asleep and user computing device 150A is not being utilized).

Availability determination system 120 may determine, based on the inference, whether to authorize processing of transactions initiated on the account of the user. In the case of the previous example, availability determination system 120 may determine that, since the user is currently physically unavailable, subsequently initiated transactions on the user’s account should not be authorized for processing. In this example, availability determination system 120 may operate as a gatekeeper to prevent the “normal” or standard processing, e.g., by transaction management system 116, of the transactions initiated on the user’s account while the user is physically unavailable.

Based on the determination, availability determination system 120 may send a message to another computing system, such as transaction management system 116, which may cause transaction management system 116 to take one or more actions, such as blocking or allowing the transaction on the account of the user. For example, in the scenario where availability determination system 120 determines that a transaction initiated on the user’s account is not authorized for processing, availability determination system 120 may send a message to transaction management system 116 instructing transaction management system 116 to automatically block the transaction without needing to perform the “normal” or standard processing. More specifically, transaction management system 116 may automatically block or not complete the transaction without performing the standard authorization, authentication, and/or settlement steps typically performed to process a transaction.

In other examples, in the scenario where availability determination system 120 determines that a transaction initiated on the user’s account is not authorized for processing, availability determination system 120 may send a message another computing system, such as settings configuration system 112, to change or “toggle” the status of one or more payment vehicles (e.g., accounts, cards, etc.) of the user. For example, availability determination system 120 may send a message to settings configuration system 112 instructing settings configuration system 112 to turn off one or more credit cards and/or debit cards associated with the user’s accounts. In this way, availability determination system 120 may proactively block subsequent transactions from being initiated on the user’s accounts while the user is physically unavailable.

In some examples, the message may direct transaction management system 116 to only block newly initiated transactions, and to not block pending or recurring transactions (e.g., scheduled or periodic transactions). That is, availability determination system 120, in conjunction with other systems, such as transaction management system 116, may determine what transactions are pending, scheduled, or periodic, and may allow the transactions to be processed in accordance with the standard operating procedures of transaction management system 116. In some examples, availability determination system 120 may determine whether a transaction is pending, scheduled, or periodic, based on information related to the transaction (e.g., timestamps, identification codes, categories, flags, etc.). For example, a pending transaction may include a transaction that was previously initiated by the user, prior to the user being physically unavailable, but has not yet been fully processed (e.g., no transfer of payment or value has been completed). In other examples, availability determination system 120 may determine whether a transaction is periodic based on the transaction history of the account. For example, a user may set up automatic bill pay or another service to automatically complete a transaction (e.g., paying a power bill) on the second of every month. availability determination system 120 may determine a transaction (e.g., the current month’s payment) is periodic, given the account history. When availability determination system 120 determines a transaction is pending, scheduled, or periodic, availability determination system 120 may approve the transaction, or allow it to be processed in the standard procedures associated with transaction management system 116, regardless of the availability of the user.

In some examples, availability determination system 120 may obtain one or more user preferences for transaction authorization from settings configuration system 112. For example, a user may communicate with settings configuration system 112 (e.g., using one of user computing devices 150) to set one or more user preferences, such as a monetary threshold a transaction must reach or exceed before being blocked. For example, a user may set a preference that transactions should be authorized, even if the user is determined to be unavailable, if the value of the transaction does not exceed $1,000. Availability determination system 120 may obtain the user preferences and determine whether to authorize processing of the transaction. Based on the determination, availability determination system 120 may direct transaction management system 116 to block or allow a transaction.

In some examples, availability determination system 120 may operate as a service that may be queried by one or more computing devices and/or systems external to network 130 (e.g., third-party systems 140). In some examples, availability determination system 120 may operate a service that allows third-party systems 140 to send one or more requests to availability determination system 120, wherein the request is to block or allow a transaction on the third-party system based on the current physical condition (e.g., physical availability) of a user. For example, one of third-party systems 140, such as a food delivery service, may receive an order request from an account associated with a user of the organization responsible for managing availability determination system 120. The food delivery service may request that availability determination system 120 determine whether to approve or block the order, based on the physical availability or unavailability of the user. For example, availability determination system 120 may direct the food delivery service to block the food order due to availability determination system 120 determining that the user is currently unavailable.

In some examples, in response to availability determination system 120 determining to not authorize processing of one or more attempted transactions, availability determination system 120 may be configured to communicate with fraud prevention system 114. For example, availability determination system 120 may send one or more messages to fraud prevention system 114 directing fraud prevention system 114 to initiate one or more actions, such as beginning an investigation into the one or more attempted transactions.

In some examples, in response to availability determination system 120 determining to not authorize processing of one or more attempted transactions, availability determination system 120 may be configured to communicate with user notification system 118. For example, availability determination system 120 may send one or more messages to user notification system 118 directing user notification system 118 to initiate one or more actions, such as transmitting one or more notifications to a user with information related to the one or more attempted transactions.

FIG. 1 illustrates only one particular example of network system 100. In the example of FIG. 1, network system 100 might include all of the components shown in FIG. 1. However, in other examples, network system 100 may include a subset of the components included and/or may include additional components not shown in FIG. 1. Each of the computing systems and/computing devices illustrated in FIG. 1 (e.g., settings configuration system 112, fraud prevention system 114, transaction management system 116, user notification system 118, availability determination system 120, third-party systems 140, and user computing devices 150) may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such systems may perform operations described herein as a result of instructions, stored on a computer-readable storage medium, executing on one or more processors. The instructions may be in the form of software stored on one or more local or remote computer readable storage devices. In other examples, one or more of such computing systems may perform operations using hardware, firmware, or a mixture of hardware, software, and firmware residing in and/or executing at each of such computing systems.

The techniques of this disclosure may provide one or more technical improvements that may be used to realize practical advantages. For example, the techniques enable availability determination system 120, in conjunction with other systems, such as transaction management system 116 and/or any of third-party systems 140, to preemptively block transactions initiated on an account during a time period in which the user is determined to be physically unavailable (e.g., asleep, working out, in a location, such as an airplane, where the given transaction would be impossible, etc.) to initiate the transactions. In this way, when a user is determined to be unavailable, availability determination system 120 may direct another system to automatically block transactions until the user overrides the block (i.e., once the user is again physically available), rather than the organization responsible for managing enterprise network 110 needing to perform a unique fraud determination for each transaction initiated on the accounts during the same time period. For example, if three transactions are attempted while a user is unavailable (e.g., asleep), the techniques of this disclosure may enable availability determination system 120 to automatically direct another system to prevent each transaction from being processed and completed, while conventional systems may require a computing system to determine the validity of each transaction individually, as each transaction is processed, or detect fraudulent or anomalous activity after a transaction is already processed, if a transaction is later flagged after passing the initial validity test. As such, these techniques may reduce resource usage (e.g., compute, storage, and/or power usage) by reducing the number of processes needed to validate a transaction, making network system 100 operate more efficiently.

The techniques may also enable availability determination system 120 to automatically monitor and place restrictions on multiple accounts. For example, with conventional methods, a user traveling may need to manually disable (e.g., temporarily deactivate, etc.) or place restrictions (e.g., block all new, unscheduled transactions) on four separate accounts, transaction methods, or payment vehicles (e.g., credit card, debit card, cryptocurrency wallet, etc.). The techniques of this disclosure may enable availability determination system 120 to automatically determine when the user is unavailable by analyzing multiple status indicators related to the user and/or a computing device, such as user computing device 150A, associated with the user. Availability determination system 120 may then automatically disable or otherwise restrict each account in response to determining the user is unavailable. As such, these techniques may reduce resource usage (e.g., compute, storage, and/or power usage) by reducing the number of events needed to toggle the usability of a payment vehicle, making network system 100 operate more efficiently.

As another example, availability determination system 120 may improve one or more ML models (e.g., one or more models stored, hosted, or otherwise managed by availability determination system 120) over time. In some examples, availability determination system 120 may be configured to obtain feedback from one or more users regarding one or more determinations of an ML model (e.g., a determination of the availability status of a user). For example, availability determination system 120 may obtain feedback from a user indicating that multiple transactions were erroneously blocked during a time when the user was physically available, but an ML model had determined the user was unavailable. Availability determination system 120 may use the user feedback to fine-tune parameters of the one or more ML models and/or as a portion of training data used to train or retrain the one or more ML models. In another example, availability determination system 120 may obtain additional status indicators from one or more of third-party systems 140, such as a microservice associated with a sleep management application. Availability determination system 120 may use the additional status indicators to fine-tune and/or retrain the one or more ML models. In these ways, the techniques enable availability determination system 120 to improve the accuracy and/or speed of one or more ML models. For example, by re-training the ML models in response to receiving user feedback that the system erroneously determined that the user was unavailable, the models may be able to properly interpret similar input conditions in future situations (e.g., properly determine a user is available). Similarly, by providing additional status indicators for the ML models to use in determining an inference, availability determination system 120 may enable the models to make more intelligent and accurate decisions.

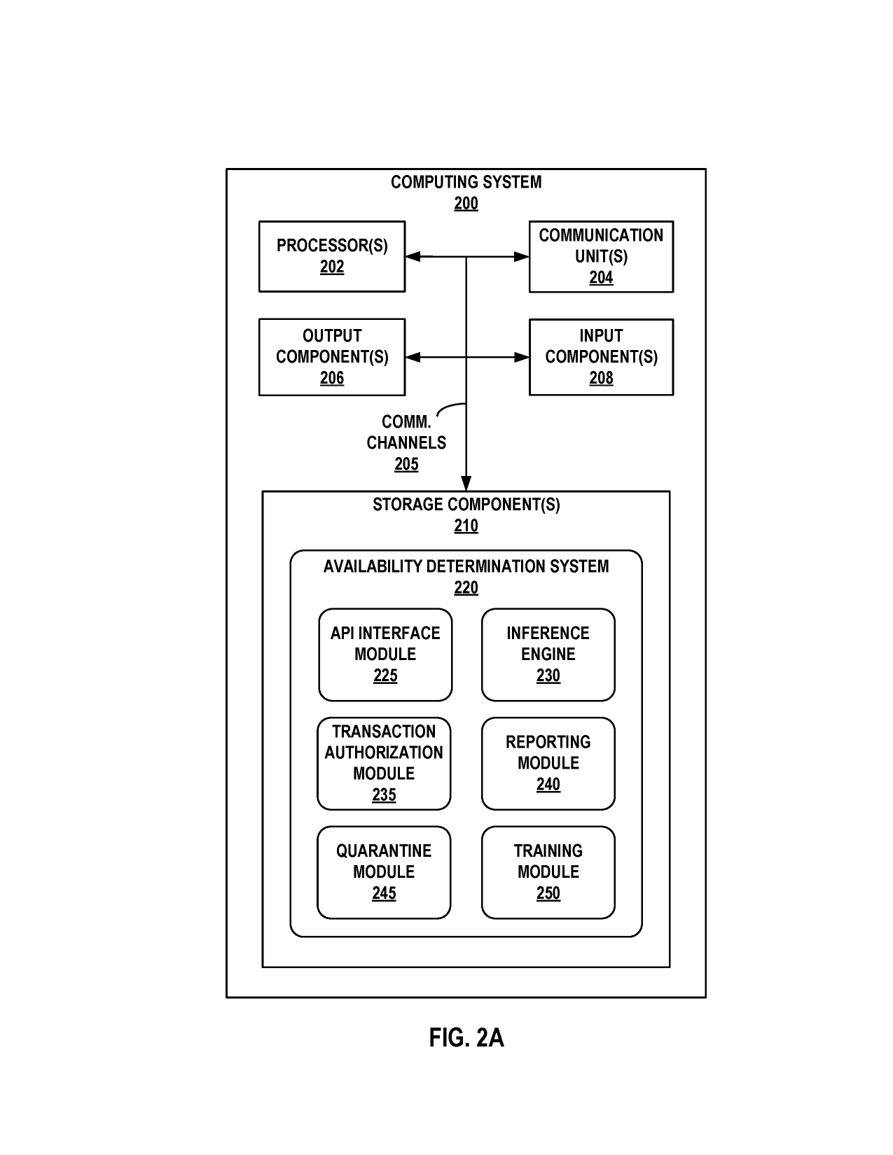

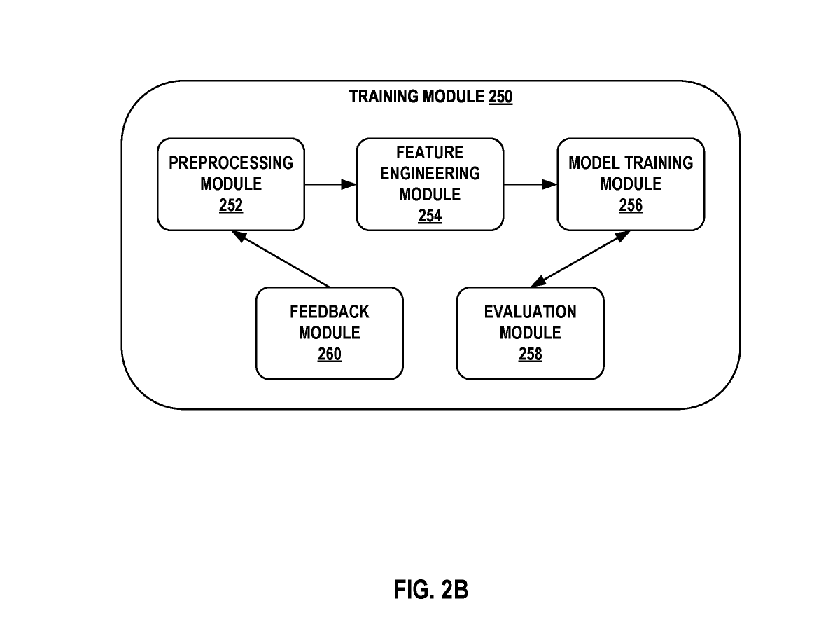

FIG. 2A is a block diagram illustrating an example computing system 200, in accordance with one or more aspects of the present disclosure. Computing system 200 executes an availability determination system 220, which may operate substantially similar to availability determination system 120 of FIG. 1.

Computing system 200 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 200 may comprise a server within a data center, cloud computing system, server farm, and/or server cluster (or portion thereof) that provides services to client devices and other devices or systems.

Although computing system 200 of FIG. 2A is illustrated as a stand-alone device, in other examples computing system 200 may be implemented in any of a wide variety of ways and may be implemented using multiple devices and/or systems. In some examples, computing system 200 may be, or may be part of, any component, device, or system that includes a processor or other suitable computing environment for processing information or executing software instructions and that operates in accordance with one or more aspects of the present disclosure. In some examples, computing system 200 may be fully implemented as hardware in one or more devices or logic elements.

In the example of FIG. 2A, computing system 200 includes one or more processors 202, one or more communication units 204, one or more output components 206, one or more input components 208, one or more communication channels 205, and one or more storage components 210. In the illustrated example, storage components 210 include API interface module 225, inference engine 230, reporting module 240, and training module 250. One or more of the devices, modules, storage areas, or other components of computing system 200 may be interconnected to enable inter-component communications (physically, communicatively, and/or operatively).

Communication channels 205 may interconnect each of the components 202, 204, 206, 208, and/or 210 for inter-component communications (physically, communicatively, and/or operatively). In some examples, communication channels 205 may include a system bus, a network connection, an inter-process communication data structure, or any other method for communicating data.

A power source (not shown) provides power to one or more components of computing system 200. In some examples, the power source may receive power from the primary alternative current (AC) power supply in a commercial building or data center, where some or all of an enterprise network may reside. In other examples, the power source may be or may include a battery.

One or more processors 202 of computing system 200 may implement functionality and/or execute instructions associated with one or more modules illustrated herein and/or described below. One or more processors 202 may be, may be part of, and/or may include processing circuitry that performs operations in accordance with one or more aspects of the present disclosure. Examples of processors 202 include microprocessors, application processors, display controllers, auxiliary processors, one or more sensor hubs, and any other hardware configured to function as a processor, a processing unit, or a processing device. Computing system 200 may use one or more processors 202 to perform operations in accordance with one or more aspects of the present disclosure using software, hardware, firmware, or a mixture of hardware, software, and firmware residing in and/or executing at computing system 200.

One or more communication units 204 of computing system 200 may communicate with devices external to computing system 200 by transmitting and/or receiving data, and may operate, in some respects, as both an input device and an output device. In some examples, communication units 204 may communicate with other devices over a network. In other examples, communication units 204 may send and/or receive radio signals on a radio network such as a cellular radio network. In other examples, communication units 204 of computing system 200 may transmit and/or receive satellite signals on a satellite network such as a Global Positioning System (GPS) network. Examples of communication units 204 include a network interface card (e.g., such as an Ethernet card), an optical transceiver, a radio frequency transceiver, a GPS receiver, or any other type of device that may send and/or receive information. Other examples of communication units 204 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more output devices 206 may represent any output devices of computing system 200 not otherwise separately described herein. One or more output devices 206 may generate, receive, and/or process input from any type of device capable of detecting input from a human or machine. For example, one or more output devices 206 may generate, receive, and/or process output in the form of electrical and/or physical output (e.g., peripheral device, actuator). For computing devices that may be used by a user, one or more output devices 206 may generate, present, and/or process output in the form of tactile, audio, visual, video, and other output. Some devices may serve as both input and output devices. For example, a communication device may both send and receive data to and from other systems or devices over a network.

One or more input devices 208 may represent any input devices of computing system 200 not otherwise separately described herein. One or more input devices 208 may generate, receive, and/or process input from any type of device capable of detecting input from a human or machine. For example, one or more input devices 208 may generate, receive, and/or process input in the form of electrical, physical, audio, image, and/or visual input (e.g., peripheral device, keyboard, microphone, camera). For computing devices that may be used by a user, one or more input devices 208 may generate or receive input from a keyboard, pointing device, voice responsive system, video camera, button, sensor, mobile input device, control pad, microphone, presence-sensitive screen, network, or any other type of device for detecting input from a human or machine.

One or more storage components 210 within computing system 200 may store information for processing during operation of computing system 200. Storage components 210 may include one or more types of storage such as hard disk drives, solid state drives (e.g., SATA drives, NVMe drives, eMMC storage, etc.), magnetic tape drives, remote storage (e.g., cloud storage), and/or other types of storage. Storage components 210 may store program instructions and/or data associated with one or more of the modules described in accordance with one or more aspects of this disclosure. One or more processors 202 and one or more storage components 210 may provide an operating environment or platform for such modules, which may be implemented as software, but may in some examples include any combination of hardware, firmware, and software. One or more processors 202 may execute instructions and one or more storage components 210 may store instructions and/or data of one or more modules. The combination of processors 202 and storage components 210 may retrieve, store, and/or execute the instructions and/or data of one or more applications, modules, or software. Processors 202 and/or storage components 210 may also be operably coupled to one or more other software and/or hardware components, including, but not limited to, one or more of the components of computing system 200 and/or one or more devices or systems illustrated as being connected to computing system 200.

In some examples, one or more storage components 210 are temporary memories, meaning that a primary purpose of the one or more storage components is not long-term storage. Storage components 210 of application computing system 200 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage components 210, in some examples, also include one or more computer-readable storage media. Storage components 210 may be configured to store larger amounts of information than volatile memory. Storage components 210 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Storage components 210, as illustrated in FIG. 2A, includes availability determination system 220 having an API interface module 225, an inference engine 230, a transaction authorization module 235, a reporting module 240, a quarantine module 245, and a training module 250. Although not illustrated in the example of FIG. 2, storage components 210 may include an operating system (OS) that may control the operations of components of computing system 200. The OS may have a kernel that facilitates interactions with underlying hardware of operations computing system 200 and provides a fully formed application space capable of executing a wide variety of software applications having secure partitions in which each of the software applications executes to perform various operations.

API interface module 225 may be configured to obtain one or more status indicators associated with a user. In some examples, a status indicator may include information indicative of one or more activity states of the user. For example, a status indicator may include information that the user is asleep, exercising, or driving. In other examples, a status indicator may include information indicative of one or more connectivity states on a user computing device associated with the user (e.g., user computing device 150A of FIG. 1). API interface module 225 may be configured to obtain status indicators on a periodic basis. For example, API interface module 225 may be configured to obtain status indicators every hour. In another example, API interface module 225 may be configured to obtain status indicators every five minutes.

In some examples, API interface module 225 may obtain a status indicator from interacting with a computing device associated with a user (e.g., user computing device 150A of FIG. 1). API interface module 225 may obtain the status indicator from a computing device by interacting with one or more APIs accessible on the computing device. As one example, API interface module 225 may obtain a status indicator from a user computing device (e.g., user computing device 150A of FIG. 1) indicating the connectivity state of the user computing device (e.g., airplane mode, bedtime mode, not connected to a cellular network, etc.). For example, availability determination system 120 may obtain a status indicator indicating that the user computing device is not connected to data or any cellular network (e.g., connected to the Internet through a non-cellular connection, such as WIFI).

In other examples, API interface module 225 may obtain a status indicator associated with a user by interacting with one or more third-party systems (e.g., third-party systems 140 of FIG. 1). A third-party system may be a cloud-based service that a user may access or interact with through one or more applications or services on any computing device associated with the user (e.g., browser applications, applications created and/or managed by a third-party organization, etc.). As one example, a third-party system may be managed by an organization that manages a fitness application. The third-party system may store fitness-related information (e.g., workout history, steps, etc.) obtained from the application as hosted on the user’s computing device (e.g., user computing device 150A of FIG. 1). API interface module 225 may obtain the status indicator from a third-party system by interacting with one or more APIs hosted or otherwise managed by the third-party system. As one example, API interface module 225 may interact with a third-party system, such as one managed by a fitness application, to obtain a status indicator related to the activity state of the user, detailing the user is currently exercising.

In some examples, the status indicators obtained by API interface module 225 may be a completed value or state. As one example, a status indicator may be obtained from one of third-party systems 140, such as one managed by a fitness application, to obtain information indicating that the user is currently exercising. In other examples, the status indicators obtained by API interface module 225 may be values used to determine one or more states. As one example, API interface module 225 may obtain multiple status indicators from one of third-party systems 140, such as one managed by a fitness application, such as a heart rate or step count.

In some examples, the one or more sources from which API interface module 225 may obtain status indicators may be set or otherwise identified by a user. For example, a user whose account is monitored by computing system 200 may interact with one or more other computing systems, such as settings configuration system 112 of FIG. 1. The user may determine the status indicators that may be obtained by API interface module 225. For example, a user may provide settings configuration system 112 information (e.g., account information, account authorization, etc.) necessary to enable API interface module 225 to interact with an API of a third-party system, such as a fitness application used by the user.

Inference engine 230 may be configured to use the one or more status indicators obtained by API interface module 225 to determine an inference associated with a physical condition of the user. Inference engine 230 may be comprised of one or more ML models trained on historical status indicators and configured to determine the physical condition of the user. The one or more ML models may be linear regression models, logistic regression models, decision tree models, random forest models, gradient boosting models, support vector machines, or any other similar model known in the art. The one or more ML models may be trained and/or updated by training module 258, discussed in further detail in FIG. 2B.

Inference engine 230 may take the one or more status indicators as input. Inference engine 230 may determine that, based on the status indicators, the user is either physically available (e.g., able to make or initiate a transaction) or physically unavailable (e.g., unable to make or initiate a transaction). For example, inference engine 230 may output an inference pertaining to the physical condition or availability of a user based on two status indicators obtained pertaining to a user – the activity state of the user and the current state of a computing device associated with the user (e.g., user computing device 150A of FIG. 1). The status indicators may show that the current activity state of the user is asleep, and that the user computing device is in a sleep mode (e.g., bedtime mode). Inference engine 230 may determine, based on the status indicators, that the user is physically unavailable to make transactions (e.g., since the user is asleep, and their device is not in use).

Transaction authorization module 235 may determine, based on the inference, whether to authorize the processing of transactions initiated on the account of the user. In the case of the previous example, transaction authorization 235 may determine that, since the user is currently physically unavailable, subsequently, newly initiated transactions should not be processed and should instead be blocked or quarantined. Based on the determination, transaction authorization module 235 may direct reporting module 240 to send a message to another computing system, such as transaction management system 116 of FIG. 1, which may cause the another computing system to take one or more actions, such as blocking or allowing the transaction on the account of the user. For example, reporting module 240 may direct transaction management system 116 to block or otherwise not process any newly initiated transactions on the user’s account until directed to operate otherwise (e.g., based on an indication that the user is physically available to initiate transactions).

In some examples, the message may direct another computing system to only block newly initiated transactions (e.g., to not block pending, scheduled, or periodic and recurring transactions). Transaction authorization module 235, in conjunction with other systems, such as transaction management system 116 of FIG. 1, may determine what transactions are pending, scheduled, or periodic, and may allow the transactions to be processed in accordance with the standard operating procedures of transaction management system 116. In some examples, transaction authorization module 235 may determine whether a transaction is pending, scheduled, or periodic, based on information related to the transaction (e.g., timestamps, identification codes, categories, flags, etc.). For example, a pending transaction may include a transaction that was previously initiated by the user, prior to the user being physically unavailable, but has not yet been fully processed (e.g., no transfer of payment or value has been completed). In other examples, transaction authorization module 235 may determine whether a transaction is periodic based on the transaction history of the account. For example, a user may set up automatic bill pay or another service to automatically complete a transaction (e.g., paying a power bill) on the second of every month. Transaction authorization module 235 may determine a transaction (e.g., the current month’s payment) is periodic. Based on determining whether a transaction is pending, scheduled, or periodic, transaction authorization module 235 may approve the transaction regardless of the availability of the user. For example, a pending transaction may include a transaction that was previously initiated by the user, prior to the user being physically unavailable, but has not yet been fully processed (e.g., no transfer of payment or value has been completed). Transaction authorization module 235 may direct another computing system (e.g., transaction management system 116 of FIG. 1) to allow the previously initiated transaction to be completed, even if the user is currently physically unavailable.

In some examples, transaction authorization module 235 may obtain, from a computing device associated with the user, an indication that the physical condition of the user has changed (e.g., that an unavailable user has become available). For example, an asleep user may wake up. In one example, transaction authorization module 235 (e.g., in conjunction with one or more other components of computing system 200, such as API interface module 225, and/or another computing system, such as user notification system 118 of FIG. 1) may obtain a status indicator with information that the activity state of the user is awake. In another example, transaction authorization module 235 may obtain an indication that the user has authenticated into their account (e.g., through a login, authentication code, vocal authentication, biometric authentication, etc.). Based on transaction authorization module 235 receiving the indication, reporting module 240 may be configured to send an updated message to another computing system, such as transaction management system 116 of FIG. 1, directing the another computing system to authorize processing of subsequently initiated transactions on the account of the user. For example, reporting module 240 may send a message to transaction management system 116 directing the system to process transactions (e.g., allow and/or block transactions) in accordance with standard operating policies of the system.

In some examples, transaction authorization module 235 may be configured to obtain multiple indications before reporting module 240 may send the updated message to another computing system. For example, transaction authorization module 235 may be configured to obtain at least one indication that physical condition of the user has changed, and at least one indication that the user has authenticated into their account. As one example, a user may be determined to be currently unavailable. Later, transaction authorization module 235 may obtain an indication from a third-party sleep tracking service that the user, who was previously determined to be asleep, is now awake. Transaction authorization module 235 may obtain another indication that the user has authenticated into their account (e.g., through a vocal authentication). Once transaction authorization module 235 has obtained both the indication related to the physical condition of the user, and the indication related to an authentication or login, transaction authorization module 235 may direct reporting module 240 to send a message to another computing system, such as transaction management system 116 of FIG. 1, directing it to authorize processing of subsequently initiated transactions on the account of the user.

In some examples, when transaction authorization module 235 determines that a user is unavailable and that computing system 200 should not authorize the processing of subsequent transactions, quarantine module 245 may be configured to quarantine newly initiated transactions. Quarantine module 245 may be configured to obtain (e.g., in conjunction with another computing system, such as user notification system 118 of FIG. 1) an indication of approval related to the quarantined transaction (e.g., whether or not the user approves the transaction to be processed). For example, quarantine module 245 may obtain an indication from a computing device associated with the user, such as a login attempt, response to a push notification (e.g., from one or more applications on the user computing device), or a text message. If the indication is related to the approval of the transaction, quarantine module 245 may direct reporting module 240 to send a message to another computing system, such as transaction management system 116 of FIG. 1, to approve processing of the transaction on the account of the user. Conversely, if the indication is related to the denial of the transaction, quarantine module 245 may direct reporting module 240 to send a message to another computing system, such as transaction management system 116, to block the transaction on the account of the user.

In some examples, such as when the user does not respond to an approval request for a quarantined transaction, quarantine module 245 may determine whether there are additional authorized users associated with the account (e.g., spouses, parents, children, business partners, etc.). Quarantine module 245 may be configured to obtain, from a second authorized user, an indication of approval or disapproval related to a transaction. Based on the indication from the second authorized user, quarantine module 245 may direct reporting module 240 to send a message directing another computing system, such as transaction management system 116 of FIG. 1, to allow or block the transaction.

In some examples, transaction authorization module 235 may obtain one or more user preferences or configuration settings from another computing system, such as settings configuration system 112 of FIG. 1. For example, a user may communicate with settings configuration system 112 (e.g., using user computing devices 150A of FIG. 1) to set one or more user preferences, such as a monetary threshold a transaction must reach or exceed before being blocked. For example, a user may set a user preference that they only want transactions to be blocked if the value of the transaction is at least $1,000. Transaction authorization module 235 may obtain the user preferences and determine whether to authorize processing of newly initiated transactions in line with the user preferences. For example, when a user is physically unavailable, transaction authorization module 235 may authorize processing of a transaction for $500, while not authorizing and blocking another transaction for $1,250.

In some examples, a user may set one or more preferences regarding alerting notifications (e.g., calls, messages, push notifications, alarms, etc.) that may be sent to the user in response to a transaction. For example, in addition to a preference regarding a monetary threshold for the authorization and/or blocking of a transaction, a user may set a preference regarding the monetary threshold for the alerting of a transaction. As one example, a user may set a preference that they want to be alerted for any transactions wherein the monetary value is at least $5,000. When a transaction for $5,000 occurs, transaction authorization module 235 may direct user notification system 118 to alert the user (e.g., through a call, an alert on a user computing device, etc.). In some examples, the user may be alerted regardless of their availability status. In some examples, when the user is unavailable, and is alerted by user notification system 118 in response to one or more user preferences, transaction authorization module 235, in conjunction with other systems, such as user notification system 118, may determine whether the user received or otherwise responded to the alert. For example, if user notification system 118 alerts the user of a transaction through a call, user notification system 118 may determine whether the user received, interacted with, or responded to the call (e.g., answered the call, responded to a prompt during the call, etc.). If the user interacted with the alert, transaction authorization module 235 may use the interaction as an indication that the physical condition of the user has changed (e.g., that an unavailable user may have become available). In the case of the previous example, the user may have been determined to be unavailable due to status indicators indicating the user was asleep, and their user computing device was operating in airplane mode. Upon receiving the call, the user interacted with the call by answering the call and dialing a number on the receiving device’s keypad. Transaction authorization module 235 may determine that the user’s physical condition has changed, since the asleep user interacted with call, and provide this as a status indicator to inference engine 230.

In some examples, based on transaction authorization module 235 not authorizing processing of and/or blocking one or more transactions, reporting module 240 may be configured to communicate with fraud prevention system 114 of FIG. 1. For example, reporting module 240 may send one or more messages to fraud prevention system 114 directing fraud prevention system 114 to initiate one or more actions, such as beginning an investigation into the transaction that was initiated while the user was physically unavailable.

In some examples, based on transaction authorization module 235 not authorizing processing of and/or blocking one or more transactions, reporting module 240 may be configured to communicate with user notification system 118 of FIG. 1. For example, reporting module 240 may send one or more messages to user notification system 118 directing user notification system 118 to initiate one or more actions, such as transmitting one or notifications to the user with information related to the attempted transaction.

Computing system 200, as is illustrated in FIG. 2A, may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices.

FIG. 2B is a conceptual diagram illustrating an example operation of training inference engine 230 of FIG. 2A, in accordance with one or more aspects of the present disclosure. FIG. 2B includes preprocessing module 252, feature engineering module 254, model training module 256, evaluation module 258, and feedback module 260, which may each perform one or more functions of training module 250, as is described in FIG. 2A.

Preprocessing module 252 may be responsible for preprocessing information obtained by API interface module 225. In some examples, preprocessing module 252 may be configured to consolidate each of the status indicators associated with a given user. In other examples, preprocessing module 252 may be configured to clean or otherwise alter the status indicators. For example, preprocessing module 252 may remove duplicate status indicators (e.g., status indicators that were obtained multiple times by API interface module 225). As another example, preprocessing module 220 may fill in missing status indicator values (e.g., based on historical values, based on standard values, etc.). As another example, preprocessing module 252 may ensure that the status indicators obtained are consistent with one another. For example, preprocessing module 252 may receive status indicators for two users from the same data source, such as “asleep” and “ASLP.” Preprocessing module 252 may be configured to standardize the values, such as by converting both values to “asleep,” or converting both values to new values (e.g., embedding or vectorizing the status indicators).

Feature engineering module 254 may be configured to perform one or more feature engineering actions on the status indicators. For example, feature engineering module 254 may select, remove, or otherwise choose which status indicators to use to train the one or more ML models comprising inference engine 230.

Model training module 256 may be configured to perform one or more actions associated with the initial training process of one or more ML models. In some examples, model training module 256 may be configured to create training, validation, and/or test datasets. For example, model training module 256 may create a training dataset for one or more models based on historical status indicators obtained for a plurality of different users and/or user computing devices (e.g., user computing devices 150 of FIG. 1). Model training module 256 may use the training and test datasets created to train one or more ML models of the inference engine to determine the physical condition of the user based on the one or more status indicators of the user or the user computing device of the user. Model training module 256 may use the validation dataset to perform hyperparameter tuning on the one or more ML models (e.g., finding the optimal values for parameters associated with the learning process of the ML models).

Evaluation module 258 may be configured to evaluate the performance of one or more ML models. Evaluation module 258 may evaluate the performance of the model on the test dataset generated by model training module 256 with respect to one or more performance metrics (e.g., accuracy, precision, recall, mean squared error, etc.). If a model fails to meet one or more minimum performance requirements (e.g., a minimum level of accuracy), evaluation module may direct model training module 256 to improve the model (e.g., select new features, re-train the model with new parameters, etc.).

Feedback module 260 may be configured to obtain feedback with respect to one or more actions of computing system 200 (e.g., in conjunction with one or more other components and/or computing systems, such as user notification system 118 of FIG. 1). For example, feedback module 260 may obtain feedback with respect to the blockage or allowance of one or more transactions associated with the account of a user, as directed by availability determination system 220 of FIG. 2A. Feedback module 258 may be configured to cause training module 250 to retrain one or more ML models based at least in part on the feedback obtained. For example, feedback module 260 may obtain feedback from a user that a transaction was erroneously blocked on their account after inference engine 230 erroneously determined the user was unavailable and reporting module 240 directed another computing system (e.g., transaction management system 116 of FIG. 1) to block the transaction. Feedback module 260 may use the feedback to re-train models to more accurately determine the physical condition and availability of the user in the future, in accordance with one or more aspects of this disclosure.

FIG. 2B illustrates only one particular example of training module 250. In the example of FIG. 2B, training module 250 might include all of the components shown in FIG. 2B. However, in other examples, training module 250 may include a subset of the components included or may include additional components not shown in FIG. 2B.

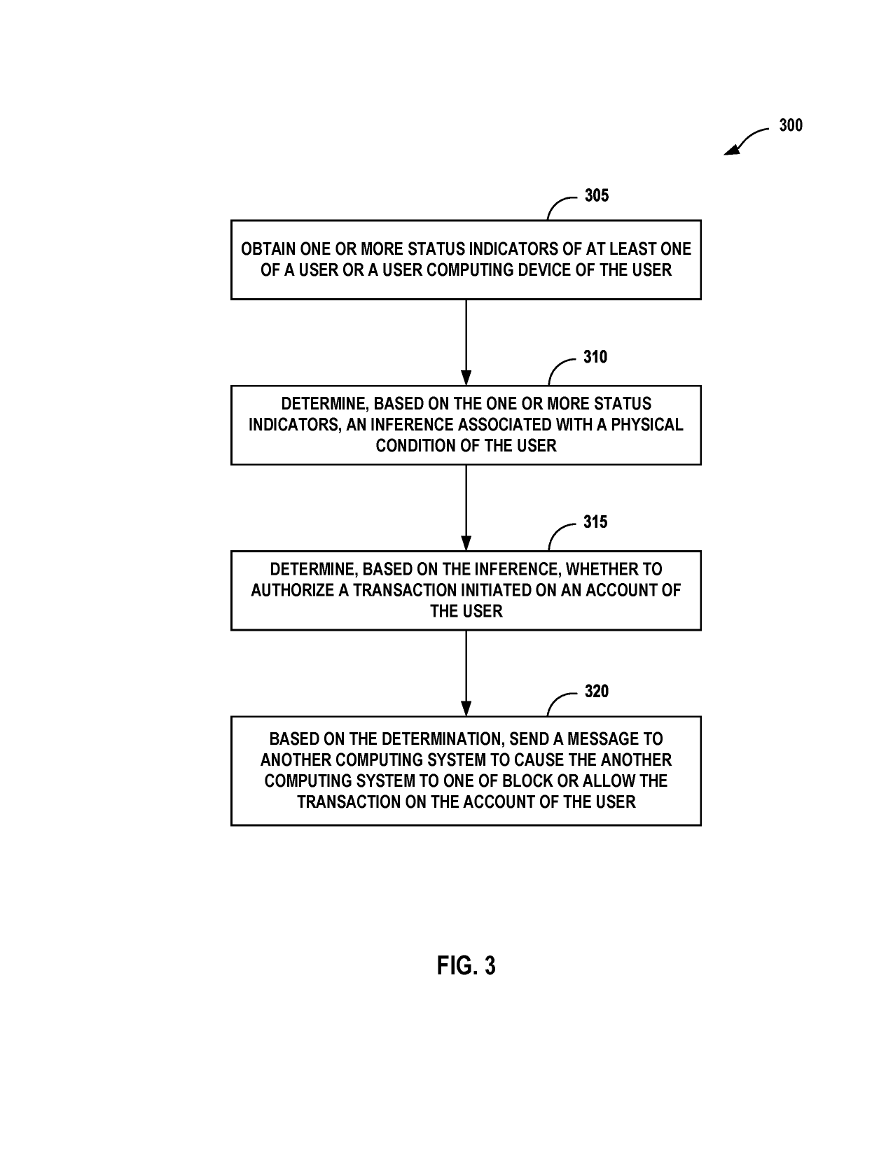

FIG. 3 is a flow diagram illustrating an example operation of determining the physical availability of a user and blocking or approving a transaction of the user, in accordance with one or more techniques of this disclosure. FIG. 3 is described below within the context of computing system 200 executing availability determination system 220 of FIG. 2A. In other examples, operations described in FIG. 3 may be performed by availability determination system 120 of FIG. 1, or one or more other components, modules, systems, or devices. Further, in other examples, operations described in connection with FIG. 3 may be merged, performed in a different sequence, omitted, or may encompass additional operations not specifically illustrated or described.

In the process illustrated in FIG. 3, and in accordance with one or more aspects of the present disclosure, computing system 200 obtains one or more status indicators of at least one of a user or a user computing device of the user (305). For example, API interface module 225 of computing system 200 may interact with one or more APIs (e.g., managed by third-party systems 140 and/or user computing devices 150 of FIG. 1) to obtain one or more status indicators related to the activity states of a user and/or the connectivity states of a user computing device associated with the user.

Computing system 200 determines, based on the one or more status indicators, an inference associated with a physical condition of the user (310). For example, components of computing system 200 may provide the one or more status indicators as input to inference engine 230. Inference engine 230 may provide, as output, an inference associated with the physical condition and physical availability of a user based on the status indicators obtained by API interface module 225. In some examples, components of computing system 200 (e.g., training module 250) may create training data including a plurality of status indicators of a plurality of users and a plurality of user computing devices (e.g., user computing devices 150 of FIG. 1) and train inference engine 230 to infer the physical condition of the user based on the one or more status indicators of the user or the user computing device of the user. In some examples, components of computing system 200 may obtain feedback with respect to blockage or allowance of one or more transactions. Training module 250 may update (e.g., retrain) inference engine 230 based at least in part on the feedback.

Computing system 200 determines, based on the inference, whether to authorize processing of a transaction initiated on an account of the user (315). For example, if inference engine 230 generates an inference that the user is physically unavailable to complete a transaction initiated on the account of the user, components of computing system 200240 may determine to not authorize processing of the transaction on the account of the user.

Based on the determination, computing system 200 sends a message to another computing system to cause the another computing system to one of block or allow the transaction on the account of the user (320). For example, reporting module 240 may send a message to another computing system, such as transaction management system 116 of FIG. 1, directing the system to block or allow the transaction on the account of the user. In some examples, based on a determination to not authorize processing of the transaction, reporting module 240 may quarantine a transaction on the account of the user. Reporting module 240, in conjunction with other components of computing system 200, may obtain an indication of approval of the quarantined transaction from the user via the user computing device. Based on the indication of approval, reporting module 240 may release the transaction from quarantine and send a message to transaction management system 116 to cause the system to allow the transaction on the account of the user.

In some examples, when inference engine 230 determines that the user is physically unavailable to initiate a transaction, reporting module 240 may send a message to transaction management system 116 to block all transactions initiated on the account of the user until reporting module 240, in conjunction with other components of computing system 200, obtains an indication that the user is physically available to initiate transactions. In some examples, reporting module 240 may obtain one or more user preferences associated with transaction authorization (e.g., a monetary threshold for transaction denial) from another computing system, such as settings configuration system 112 of FIG. 1. Based on an inference that the user is physically unavailable to initiate a transaction, reporting module 240, in conjunction with systems such as transaction management system 112, may determine whether to authorize processing of the transaction based on whether the transaction satisfies any of the user preferences.

For processes, apparatuses, and other examples or illustrations described herein, including in any flowcharts or flow diagrams, certain operations, acts, steps, or events included in any of the techniques described herein may be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, a limited number of devices or systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other examples. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some examples, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For example, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of computer programs from one place to another, e.g., according to a communication protocol. In this manner, computer-readable storage media generally may correspond to (1) tangible computer-readable storage media which is non-transitory or (2) a communication media such as signal or carrier wave. Data storage media may be any available media that may be accessed by one or more computers or one or more processing circuits to receive instructs, code and/or data structures for implementation of the techniques described in this disclosure. A computer program product may include a computer-readable medium.

By way of example and not limitation, such computer-readable storage media may include RAM, ROM, EEPROM, CD-ROM, or other optical disk storage, magnetic disk storage, or other magnetic storage devices, flash memory, cache memory, or any other medium that may be used to store desired program code in the form of instructions or store data structures and that may be access by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For example, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor” as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A system comprising:
memory; and
one or more processors in communication with the memory and configured to:
obtain one or more status indicators of at least one of a user or a user computing device of the user;
determine, based on the one or more status indicators, an inference associated with a physical condition of the user;
determine, based on the inference, whether to authorize processing of a transaction initiated on an account of the user; and
based on the determination, send a message to another computing system to cause the another computing system to one of block or allow the transaction on the account of the user.

2. The system of claim 1, wherein to obtain the one or more status indicators, the one or more processors are configured to:
transmit a request for at least one status indicator to one or more application programming interfaces (APIs) of one or more of the user computing device or a third-party service accessible by the user computing device; and
obtain, from the one or more APIs, the one or more status indicators.

3. The system of claim 1, wherein the one or more status indicators of the user include information indicative of one or more activity states of the user.

4. The system of claim 1, wherein the one or more status indicators of the user computing device include information indicative of one or more connectivity states of the user computing device of the user.

5. The system of claim 1, wherein to determine the inference, the one or more processors are configured to:
provide the one or more status indicators as input to a machine learning (ML) inference engine; and
obtain, as output from the ML inference engine, the inference associated with the physical condition of the user.

6. The system of claim 5, wherein the one or more processors are configured to:
obtain feedback with respect to blockage or allowance of one or more transactions; and
update the ML inference engine based at least in part on the feedback.

7. The system of claim 5, wherein the one or more processors are configured to:
create training data including a plurality of status indicators of a plurality of users and a plurality of user computing devices; and
train the ML inference engine to infer the physical condition of the user based on the one or more status indicators of the at least one of the user or the user computing device of the user.

8. The system of claim 1, wherein the one or more processors are configured to:
based on a determination to not authorize processing of the transaction, quarantine the transaction on the account of the user; and
wherein to send the message to the another computing system, the one or more processors are configured to:
obtain, from the user computing device, an indication of one of disapproval or approval of the quarantined transaction; and
based on the indication, send the message to the another computing system to cause the another computing system to one of block or allow the transaction on the account of the user.

9. The system of claim 1, wherein the user comprises a first authorized user of the account, wherein the one or more processors are configured to:
based on a determination to not authorize processing of the transaction based on the inference associated with the physical condition of the first authorized user, send a message to a second computing device of a second authorized user of the account; and
wherein to send the message to the another computing system, the one or more processors are configured to:
obtain, from the second computing device of the second authorized user of the account, an indication of one of disapproval or approval of the transaction; and
based on the indication, send the message to the another computing system to cause the another computing system to one of block or allow the transaction on the account.

10. The system of claim 1,
wherein to determine whether to authorize processing of the transaction, the one or more processors are configured to, based on an inference that the user is physically unavailable to initiate the transaction, determine to not authorize processing of the transaction; and
wherein to send the message to the another computing system, the one or more processor are configured to send the message to cause the another computing system to block the transaction on the account of the user.

11. The system of claim 10, wherein, based on the inference that the user is physically unavailable to initiate the transaction, the one or more processors are configured to not authorize processing of subsequently initiated transactions on the account of the user until obtaining an indication that the user is physically available to initiate transactions.

12. The system of claim 10, wherein the one or more processors are configured to:
obtain, from the user computing device, an indication that the user is physically available to initiate transactions; and
based on the indication, authorize processing of subsequently initiated transactions on the account of the user.

13. The system of claim 1, wherein to determine whether to authorize processing of the transaction, the one or more processors are configured to:
obtain one or more user preferences associated with transaction authorization; and
based on an inference that the user is physically unavailable to initiate the transaction and based on the transaction satisfying at least one of the user preferences, determine whether to authorize processing of the transaction.

14. A method comprising:
obtaining, by a computing system, one or more status indicators of at least one of a user or a user computing device of the user;
determining, by the computing system and based on the one or more status indicators, an inference associated with a physical condition of the user;
determining, by the computing system and based on the inference, whether to authorize processing of a transaction initiated on an account of the user; and
based on the determination, sending a message from the computing system to another computing system to cause the another computing system to one of block or allow the transaction on the account of the user.

15. The method of claim 14, wherein determining the inference comprises:
providing the one or more status indicators as input to a machine learning (ML) inference engine; and
obtaining, as output from the ML inference engine, the inference associated with the physical condition of the user.

16. The method of claim 14, further comprising:
based on a determination to not authorize processing of the transaction, quarantining, by the computing system, the transaction on the account of the user; and
wherein sending the message to the another computing system comprises:
obtaining, by the computing system and from the user computing device, an indication of one of disapproval or approval of the quarantined transaction; and
based on the indication, sending, from the computing system and to the another computing system, the message to cause the another computing system to one of block or allow the transaction on the account of the user.

17. The method of claim 14, wherein the user comprises a first authorized user of the account, and wherein the method further comprises:
based on a determination to not authorize processing of the transaction based on the inference associated with the physical condition of the first authorized user, sending, by the computing system, a message to a second computing device of a second authorized user of the account; and
wherein sending the message to the another computing system comprises:
obtaining, by the computing system and from the second computing device of the second authorized user of the account, an indication of one of disapproval or approval of the transaction; and
based on the indication, sending, from the computing system, the message to the another computing system to cause the another computing system to one of block or allow the transaction on the account.

18. The method of claim 14, wherein determining whether to authorize processing of the transaction comprises determining, by the computing system and based on an inference that the user is physically unavailable to initiate the transaction, to not authorize processing of the transaction; and
wherein sending the message to the another computing system comprises sending, by the computing system, the message to cause the another computing system to block the transaction on the account of the user.

19. The method of claim 18, wherein, based on the inference that the user is physically unavailable to initiate the transaction, the method further comprises not authorizing, by the computing system, processing of subsequently initiated transactions on the account of the user until obtaining an indication that the user is physically available to initiate transactions.

20. Non-transitory computer-readable storage media comprising instructions that, when
executed, cause one or more processors to:
obtain one or more status indicators of at least one of a user or a user computing device of the user;
determine, based on the one or more status indicators, an inference associated with a physical condition of the user;
determine, based on the inference, whether to authorize processing of a transaction initiated on an account of the user; and
based on the determination, send a message to another computing system to cause the another computing system to one of block or allow the transaction on the account of the user.
